(19) United States
(12) Patent Application Publication
(10) Pub. No.: US 2010/0171399 A1
(43) Pub. Date: Jul. 8, 2010

(54) CARD LOCK MECHANISM AND USES

(75) Inventor: Ying Zheng, Jinhua (CN)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: MERIDIAN LM MANUFACTURING CO., LTD., Jinhua (CN)

(21) Appl. No.: 12/406,406

(22) Filed: Mar. 18, 2009

(30) Foreign Application Priority Data
Mar. 18, 2008 (CN) 200820084381.6
Oct. 9, 2008 (CN) 200820165084.4

(51) Int. Cl. E05B 65/46; E05B 15/06; E05B 65/44; E05B 65/00

(52) U.S. Cl. 312/216; 70/346; 70/82; 70/77

(57) ABSTRACT

A card lock apparatus is provided. The apparatus has a slot for receiving a key card with a plurality of perforations. The perforations align with a plurality of pins within the house of the card lock apparatus. The pins are moved upward by the inserted card and then urged downward into an aligned perforation. Each pin has a seat for supporting the biasing element and engaging a notch within the actuator. The position of the seat determines whether the actuator is moveable. When all seats are substantially aligned the actuator is traversable to an unlocked position by a manually moveable member. A manually moveable member disengages the device from the enclosure allowing the enclosure to open.

### CROSS-REFERENCE TO RELATED APPLICATIONS

The present application claims the benefit of Chinese Patent Applications 200820165084.4 filed Oct. 9, 2008 and 200820084381.6 filed Mar. 18, 2008, which are incorporated herein by reference.

### TECHNICAL FIELD

The disclosure relates to a locking mechanism operable with a non-rotatable key.

### BACKGROUND INFORMATION

The prior art is replete with various types of locks using a key. Such keys are of various types in accordance with the kinds of locks. Typically, one or both sides of such a key is formed with concave grooves. In the key making process, substantial time and expense is required.

Further, the process of operating a lock and making a key is very problematic. The key needs to be rotated and unlocked in the hole of a lock. This creates an opportunity for the key to be bent or the lock to be broken. Also, the concave portion on the sides of the key is limited in the changeable degree. Formation of sharp concave portions is impossible. This limits the number of combinations available from a single key design. Therefore, unlocking operations by a similar key is very easy which creates an opportunity for a skilled thief.

Accordingly, there is a need for locking device operable with a non-rotatable key that is simple to construct and inexpensive to manufacture.

### SUMMARY

In accordance with one aspect of the present invention, a card lock apparatus has a slot for receiving a key card with a plurality of perforations. The perforations align with a plurality of pins within the house of the card lock apparatus. The pins are moved upward by the inserted card and then urged downward into an aligned perforation. Each pin has a seat for supporting the biasing element and engaging a notch within the actuator. The position of the seat determines whether the actuator is moveable. When all seats are substantially aligned the actuator is traversable to an unlocked position by a manually moveable member. A manually moveable member disengages the device from the enclosure allowing the enclosure to open.

In an embodiment the apparatus is combined with a storage cabinet. The turn knob is fixed in the locked position until the actuator is moved to the unlocked position. In the unlocked position the turn knob is free to rotate which in turn rotates an arm connected to a latching mechanism within the cabinet. When the latching mechanism is moved to an unlocked position the drawers are free to open.

### BRIEF DESCRIPTION OF THE DRAWINGS

These and other features and advantages of the present invention will be better understood by reading the following detailed description, taken together with the drawings wherein:

FIG. 1 is a structure diagram of a card lock mechanism;

FIG. 2 is a structure diagram of a card lock mechanism with the actuator moved after the card is inserted;

FIG. 3 is a structure diagram of a card lock mechanism with a rotated turn knob;

FIG. 4 is a local structure diagram of the actuator and short pin;

FIG. 5 is a section view of A-A of FIG. 4;

FIG. 6 is a local structure diagram of the actuator and short pin after the card is inserted;

FIG. 7 is a section view of B-B of FIG. 6;

FIG. 8 is a local structure diagram of the actuator and long pin;

FIG. 9 is a section view of C-C of FIG. 8;

FIG. 10 is a local structure diagram of the actuator and the long pin after the card is inserted;

FIG. 11 is a section view of D-D of FIG. 10;

FIG. 12 is a structure diagram of the card lock mechanism having a fork plate;

FIG. 13 is a structure diagram of the lock mechanism combined with cabinet drawers;

FIG. 14 is an exploded view of a card lock mechanism combined with a cabinet and drawers;

FIG. 15 is a magnification and exploded view of a self locking device on a drawer;

FIG. 16 is a magnification view of a self locking device on a drawer;

FIG. 17 is a magnification of a top view of a self locking device on a drawer;

FIG. 18 is a magnification view of a drawer latch mechanism on a cabinet with drawers; and

FIG. 19 is the turn knob and the connecting arm.

### DETAILED DESCRIPTION OF THE PREFERRED EMBODIMENTS

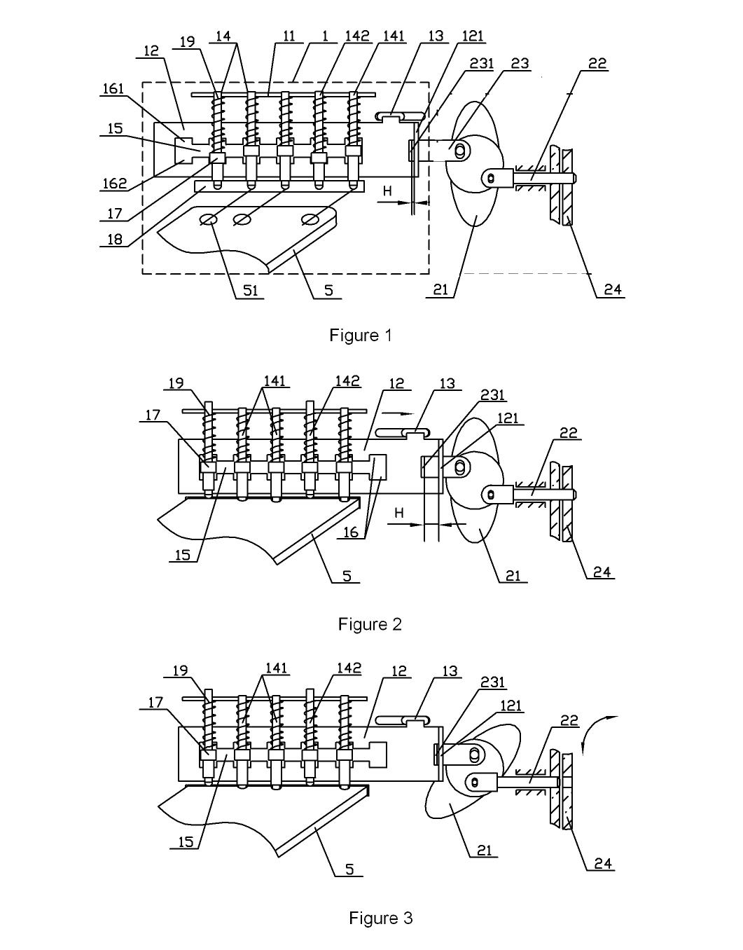

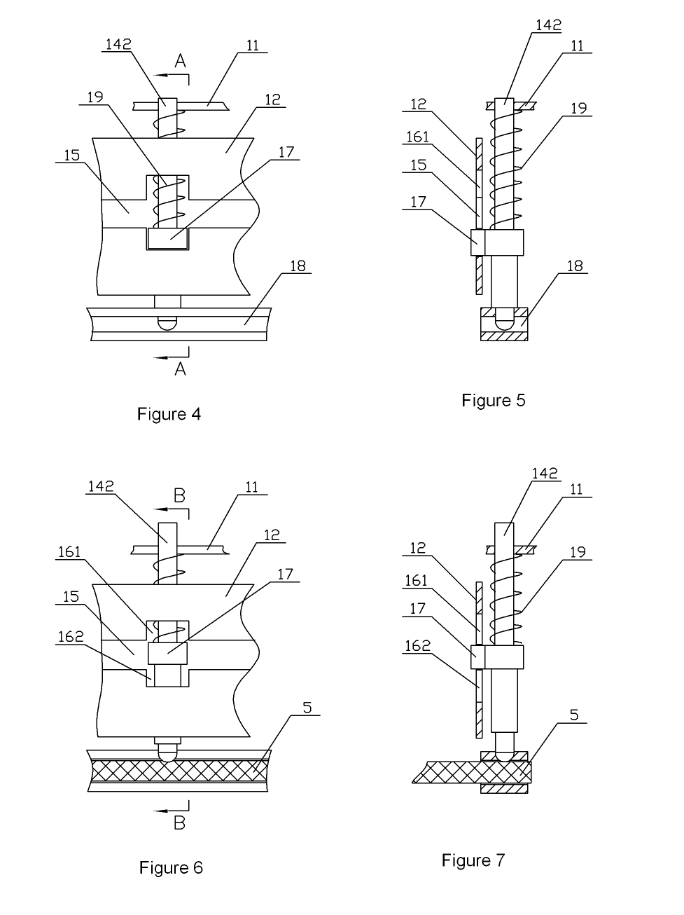

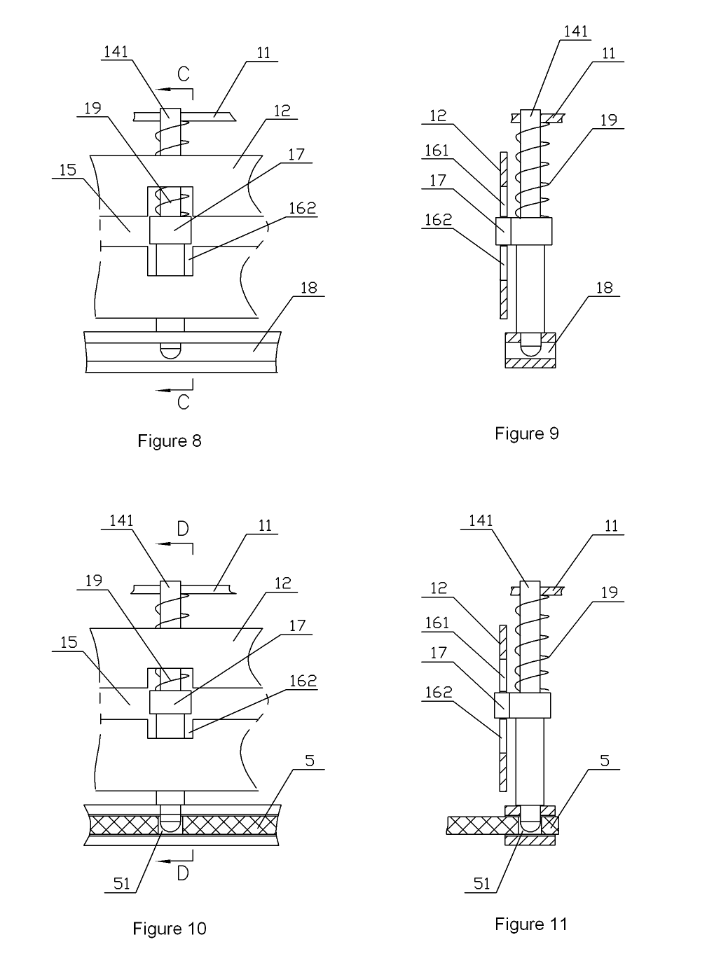

A card lock mechanism adaptable to hinged doors, such as storage lockers, is illustrated in FIGS. 1-11. The disclosed card lock mechanism is advantageous because of its inexpensive construction and ease of manufacture. Moreover, the key card 5, (hereinafter “card”) provides numerous combinations merely by varying the location of perforations 51. And, because of its size it is easily carried within a person's wallet. To operate, the user merely inserts the card 5 into a slot 18 in the mechanism. If the card 5 mates with the mechanism, a manually moveable member 13 is provided to traverse an internal actuator 12 to unlock the door. In alternate embodiments, the manually moveable member 13 may be a combination slide lock and turn knob 21. In this embodiment the user can traverse the slide lock 13 which is combined with the actuator 12. With actuator 12 traversed the turn knob 21 is free to rotate which causes a bolt 22 to disengage a receptacle 24 in a door frame—unlocking the hinged door. A more detailed explanation follows.

The card lock mechanism of the disclosed device is contained within a housing 1. The housing supports the assembly and provides its structure. The mechanism includes a plurality of pins 14 which engage perforations 51 of the card 5. The pins 14 are slidably positioned to move linearly up and down within the housing 1. Each pin 14 is formed with a seat 17 for supporting a spring 19. The spring 19 fits over the pin 14 like a sleeve and rests on the seat 17. The spring 19 is contained between the housing 1 and the seat 17. The biasing force of the spring urges the pins 14 downward while allowing for an external force provided by inserting the card 5 to push the pins 14 upward.

The actuator 12 is combined with the bolt 22 to lock and unlock the mechanism. The actuator 12 has a long slot 15 along its length which is formed with a plurality of notches 16. The number depends on the number of pins 14. There is at least one more notch 16 than there are pins 14. For example, in an embodiment with five pins 14 there are six notches 16.

The notches 16 are formed to provide a space for the seats 17 of the pins 14 to linearly traverse. Each notch 16 has a symmetric upper portion 161 and lower portion 162. The seat 17 of each pin 14 is partially located within the respective notches 16 of the actuator 12 and is linearly traversable between the upper portion 161 and lower portion 162.

In an embodiment, the pins 14 are of at least two different sizes (referred to at long pins 141 and short pins 142) to provide for more combinations. In the illustrated embodiment, five pins 14 include a combination of long pins 141 and short pins 142. The length of the pin determines the resting position of the seat 17. In the illustrated embodiment, seats 17 of the long pins 141 rest in the long slot 15 while seats 17 of the two short pins 142 rest in the lower portions 162. With a seat 17 resting in the lower portion 162, the actuator 12 cannot move. In fact, the only way the actuator 12 can traverse is if all seats 17 are located near the center line of the long slot 15.

The pins 14 are urged upward when the card 5 is inserted into the slot 18. The thickness of the card 5 corresponds to the height of the symmetric upper portion 161 and the lower portion 162. When the card 5 is inserted into the slot 18 the pins 14 are urged upward. As the card 5 is pushed inward, the perforations 51 may align with the pins 14. If a perforation 51 in the card 5 aligns with the short pin 142 the short pin is urged into the hole. The seat 17 is positioned within the lower portion 162 which prevents the actuator 12 from traversing. On the other hand, if a perforation 51 in the card 5 aligns with a long pin 141 the seat 17 of the long pin 141 is positioned along the center line of the long slot 15. With the seat 17 positioned along the center line of the long slot 15, the actuator 12 can traverse. Only when all seats 17 of the pins 14 are aligned along the center line of the long slot 15 can the actuator 12 traverse.

A stop plate 121 is connected to a slide lock 13. The user may push the slide lock 13 to the right (FIGS. 1-2) which in turn moves the actuator 12 a distance (H). Distance (H) represents the distance between the stop plate 121 and stop block 231, which is also the distance necessary to traverse the empty notch 16 to align with the far pin 14. The turn knob 21 can now rotate and disengage the bolt 22 from the receptacle 24. With the bolt 22 disengaged from the receptacle 24, the door can pivot away from the frame.

The user can remove the card 5 when the bolt 22 is disengaged. The short pins 142 are urged downward by the springs 19 which causes the seats 17 on the short pins 142 to return to rest in the lower portions 162 which locks the actuator 12 in position. When the user wishes to shut and lock the hinged door he may insert card 5 which causes the seats 17 to realign with the center line of the long slot 15. The slide lock 13 can move back to the locked position which in turn moves the actuator and causes the far notch 16 to move out of alignment with the far pin 14.

The disclosed device is capable of being designed with numerous combinations, such that the probability of any one card 5 opening an unintended door is extremely unlikely. This is advantageous for places that wish to have a high number of enclosures, such as gym locker rooms. For example, in the illustrated embodiment the locking mechanism can be disengaged only when the perforations 51 align with the long pins 141 and do not align with the short pins 142. As a result, the number of possible combinations is increased by varying the number of long pins 141 and short pins 142 and changing their respective position. Also, the location of the perforations 51 on the cards 5 can be changed to increase the number of combinations.

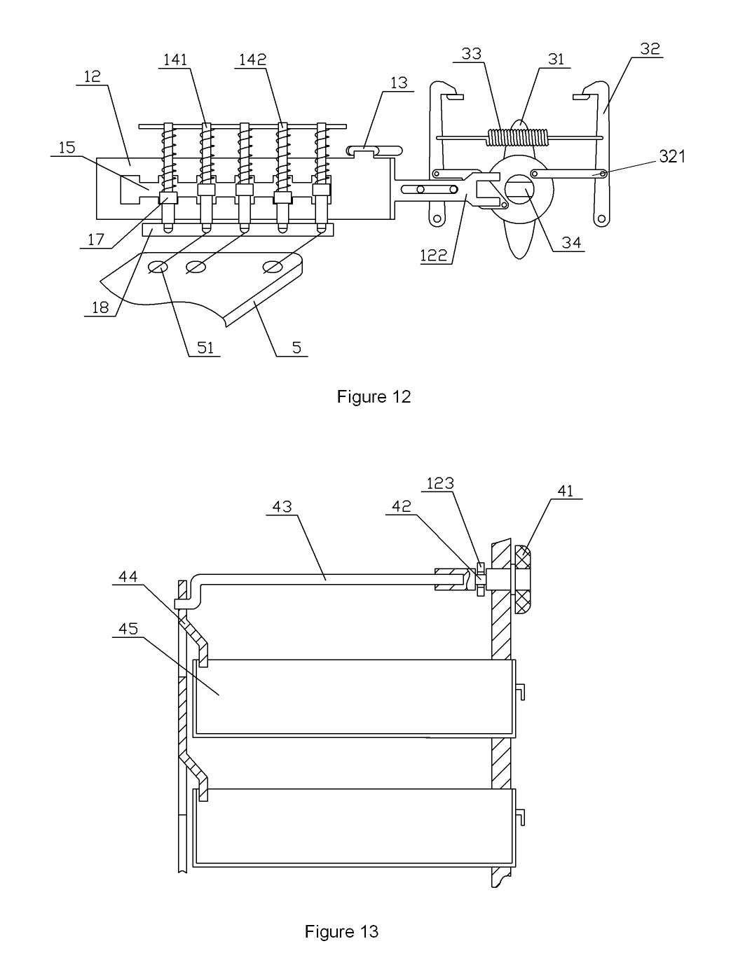

An alternate embodiment of the card lock mechanism is illustrated in FIG. 12. The illustrated embodiment has the card lock mechanism in the unlocked position. The end of the actuator 12 is combined with a fork-shaped plate 122. The fork plate 122 engages a protuberance 34 combined with a turn knob 31. When the fork plate 122 is engaged with the protuberance 34 the turn knob 31 cannot rotate which prevents the mechanism from unlocking. In FIG. 12 the fork plate 122 is traversed away from the protuberance 34 of the turn knob 31, which represents the unlocked position.

The turn knob 31 is connected to a pair of lock hooks 32 by linkages 321 which are pinned on the outer diameter of the turn knob 31. The lock hooks 32 are also biased toward each other by a spring 33. In the illustrated embodiment, when the fork plate 122 is disengaged from the turn knob 31 the turn knob 31 can rotate. When the turn knob 31 is rotated, the hooks 32 pivot outward which causes the hooks 32 to disengage the frame. The enclosure can now open.

The disclosed card lock mechanism may combine with storage boxes, such as the type for storing tools. FIG. 13 illustrates the disclosed card lock mechanism having a fork plate 123 attached to the actuator 12 combined with a storage box with multiple drawers 45. In this embodiment the turn knob 41 is connected to the arm 43 by a protuberance 42. The fork shaped plate 123 engages the protuberance 42 in a manner similar to the above disclosure. When the card lock mechanism is operated, as described above, the fork shape plate 123 traverses away from the protuberance 42. The turn knob 41 is now free to rotate. When the turn knob 41 is rotated the arm 43 rotates causing the drawer latches 44 to pivot away from the drawer 45 which allows the drawers 45 to open.

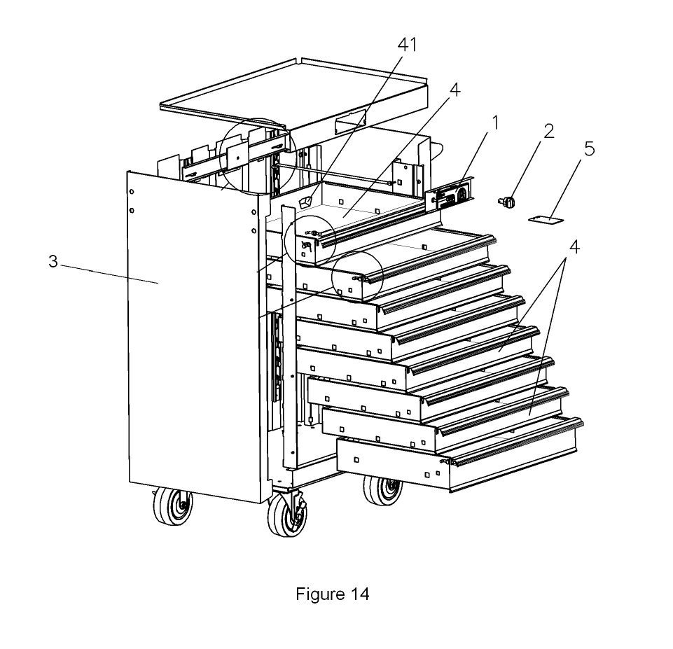

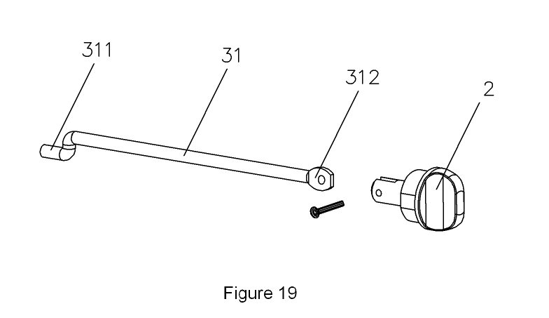

FIGS. 14 -19 disclose an embodiment of the card lock mechanism on an alternate embodiment of a storage cabinet 3. This embodiment includes a card lock mechanism 1 attached to storage cabinet body 3 having a plurality of drawers 4. As shown in FIG. 19, the back end 312 of an arm 31 connects the turn knob 2 of the card lock mechanism 1 to the drawer latch mechanism (illustrated as a combination of parts in FIG. 18). The card lock mechanism is similar to FIG. 12 in that it has a fork plate 122. When the fork plate 122 is traversed away from a protuberance 34 the turn knob 2, shown in FIG. 19, is free to rotate.

As shown in FIG. 18, the front end 311 of the connecting rod 31 engages a hole 321 in a cross bar 32. The other end of the cross bar 32 has a slot 322. The slot 322 is adapted to receive a protrusion 331 combined with a locking slide 33. The locking slide 33 traverses within a runner 34 attached to the cabinet body 3. When the turn knob 2 is rotated, the arm 31 also rotates which moves the cross bar 32 upward bringing with it the locking slide 33. When the locking slide 33 moves upward it disengages the several drawers 4 allowing the drawers 4 to open freely.

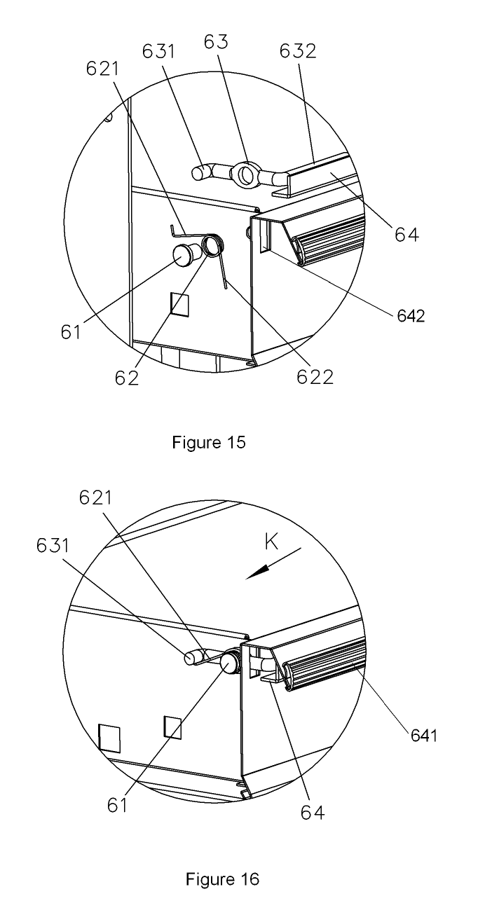

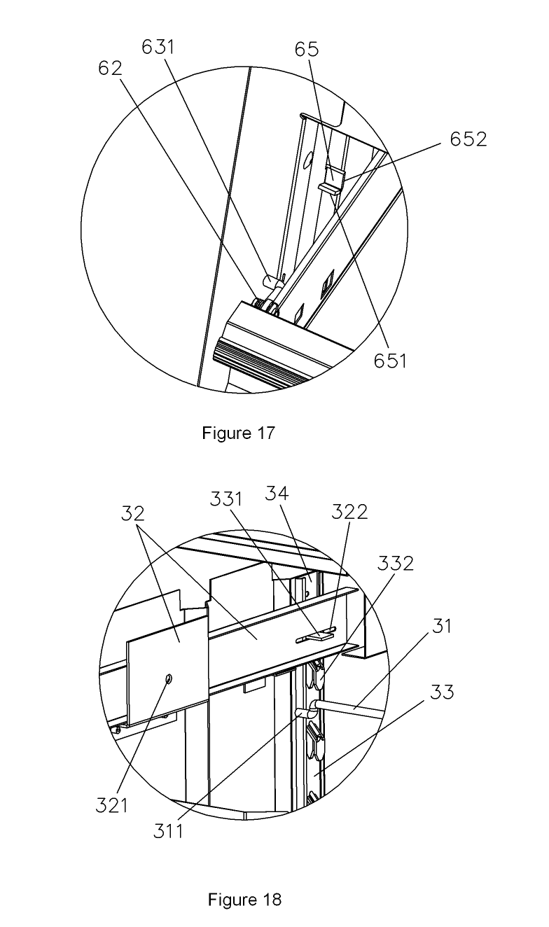

In an embodiment, each drawer 4 also has a self-locking device on at least one side. FIGS. 13 through 15 illustrate this embodiment. The self locking device prevents the drawers 4 from sliding outward when the drawer latch mechanism is disengaged. Each drawer 4 has a handle 641 that extends the length of the drawer 4. Underneath the handle 641 is a plate 64 which is attached to a pivoting arm 63 that extends the length of the drawer 4 and bends at an angle, preferably ninety-degrees, to extend through a slot 642 in the drawer 4. The pivoting arm 63 is pivotally attached to the drawer 4 by a pin 61. The pin 61 also positions a biasing element 62 which urges the pivoting arm 63 back to its normal position. In an embodiment, the biasing element 62 is a torsion spring 62. The torsion spring 62 has two arms 621 and 622 that bias the pivoting arm 63 against the drawer 4. The operation of torsion springs is well known in the art and the operation of which is incorporated herein.

The far end of the pivoting arm 63 is formed as a latch 631. The latch 631 engages a hook 65 (FIG. 17). In an embodiment, the hook 65 is attached to the cabinet 3 at its base 652. A portion of the base 652 is curved outward to form a retaining portion 651. The latch 631 in its normal position rests within the curvature of the hook 65.

Starting from the drawer 4 in the closed position, the user grabs the handle 641 and pivots the plate 64 underneath the handle 641 upward. The plate is combined with the pivoting arm 63 which also rotates. The latch 631 connected to the pivoting arm 62 rotates toward the front of the drawer 4 compressing the torsion spring 62. The latch is now disengaged from the hook 65 and the drawer can move outward.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A card lock apparatus having a slot for receiving a key card the apparatus adapted for combining with a selectively openable enclosure, said apparatus comprising:
a housing;
a plurality of pins having a seat, said pins being slidably positioned within said housing;
a plurality of springs supported by said seat and biased downward by said housing;
an actuator having a long slot and a plurality of notches for receiving said seat, wherein said seat is linearly traversable within said notch; and
a manually operated member for moving said actuator toward an unlocked position when each of said plurality of seats is substantially aligned.

2. The card lock apparatus of claim 1 wherein said manually operated member is a slide lock.

3. The card lock apparatus of claim 1 wherein said manually operated member is a turn knob;

4. The card lock apparatus of claim 3 having a slide lock combined with said actuator, wherein said slide lock traverses the actuator to an unlocked position and wherein said turn knob is rotatable to an unlocked position;

5. The card lock apparatus of claim 1 comprising a bolt combined with said manually operated member, wherein operating the manually operated member simultaneously moves said actuator to the unlocked position and retracts said bolt form the enclosure.

6. The card lock apparatus of claim 1 comprising a fork shaped plate combined with said actuator.

7. The card lock apparatus of claim 3 comprising a lock hook mechanism combined with said turn knob, wherein rotation of said turn knob pivots said lock hook mechanism to an unlocked position.

8. The card lock apparatus of claim 7 comprising a storage cabinet having a plurality of drawers, wherein said card lock apparatus is combined with said cabinet and further comprising an arm combined with said turn knob and a latching mechanism for selectively releasing said drawers, wherein rotating said turn knob rotates said arm and disengages said latching mechanism from said drawers.

9. A storage cabinet having a plurality of drawers and a card lock mechanism, said cabinet comprising:
a manually moveable member for disengaging said card lock mechanism;
an arm combined with said manually moveable member;
a cross bar combined with said arm, operating said manually moveable member moves said arm and causes said cross bar to move. a drawer latch mechanism combined with said cross bar, wherein when cross bar moves said drawer latch mechanism disengages the drawers.

10. The storage cabinet of claim 9 further comprising a self locking device, wherein said device selectively holds the drawers in a closed position.

11. The storage cabinet of claim 9 wherein said self locking device further comprises a pivoting member horizontally biased such that rotating said pivoting member causes said self locking device to disengage and allow the drawers to move to an open position.

12. A card lock apparatus having a slot for receiving a key card the apparatus adapted for combining with a selectively openable enclosure, said apparatus comprising:
a housing;
a plurality of pins having a seat, said pins being slidably positioned within said housing;
a plurality of springs supported by said seat and biased downward by said housing;
an actuator having a long slot and a plurality of notches for receiving said seat, wherein said seat is linearly moveable within said notch;
a manually operated member for moving said actuator toward an unlocked position when each of said plurality of seats is substantially aligned; and
a turn knob combined with said actuator, wherein said turn knob is rotatable when said manually moveable member is moved to the unlocked position.

13. The card lock apparatus of claim 12 wherein said manually operated member is a slide lock.

14. The card lock apparatus of claim 13 comprising a bolt combined with said turn knob, wherein operating the turn knob retracts said bolt form the enclosure.

15. The card lock apparatus of claim 13 comprising a fork shaped plate combined with said actuator.

16. The card lock apparatus of claim 15 comprising a lock hook mechanism combined with said turn knob, wherein rotation of said turn knob pivots said lock hook mechanism to an unlocked position.

17. The card lock apparatus of claim 16 comprising a storage cabinet having a plurality of drawers, wherein said card lock apparatus is combined with said cabinet and further comprising an arm combined with said turn knob and a latching mechanism for selectively releasing said drawers, wherein rotating said turn knob rotates said arm and disengages said latching mechanism from said drawers.

18. The card lock apparatus of claim 17, wherein said storage cabinet further comprises a self locking device, wherein said device selectively holds said drawer in a closed position.

19. The card lock apparatus of claim 18, wherein said self locking device further comprises a pivoting member horizontally biased such that rotating said pivoting member causes said self locking device to disengage and allow the drawers to move to an open position.
